(19) United States
(12) Patent Application Publication
(10) Pub. No.: US 2014/0370828 A1
(43) Pub. Date: Dec. 18, 2014

(54) APPARATUS AND MOBILE COMMUNICATIONS TERMINAL FOR SHARING WIRELESS LAN ANTENNA

(71) Applicant: SAMSUNG ELECTRO-MECHANICS CO., LTD., Suwon (KR)

(72) Inventors: Dae Yeol SEO, Suwon (KR); Se Jong KIM, Suwon (KR)

(73) Assignee: SAMSUNG ELECTRO-MECHANICS CO., LTD., Suwon (KR)

(21) Appl. No.: 14/023,664

(22) Filed: Sep. 11, 2013

(30) Foreign Application Priority Data
Jun. 14, 2013 (KR) 10-2013-0068625

(51) Int. Cl. H04B 1/40; H04W 88/06

(52) U.S. Cl. CPC H04B 1/401; H04W 88/06
USPC 455/90.2

(57) ABSTRACT

There is provided an apparatus for sharing a wireless LAN antenna, including: a switch connecting a signal input terminal to one of a first path, a second path and a third path; a first communications processing unit synthesizing a data signal received in a preset first communications scheme a data signal via the first path and separating a data signal to be transmitted to transmit a part of the data signal in the first communications scheme and the other part of the data signal to the second-path; a second communications processing unit transmitting a data signal via the third path in a preset second communications scheme during the receiving operation and transmitting the received data signal in the second communications scheme to the third path during the transmitting operation; a wireless LAN communications unit transmitting/receiving a wireless LAN signal to/from the first path or the first communications processing unit.

### CROSS-REFERENCE TO RELATED APPLICATIONS

This application claims the priority of Korean Patent Application No. 10-2013-0068625 filed on Jun. 14, 2013, in the Korean Intellectual Property Office, the disclosure of which is incorporated herein by reference.

### BACKGROUND OF THE INVENTION

1. Field of the Invention

The present invention relates to an apparatus and mobile communications terminal for sharing a wireless LAN antenna.

2. Description of the Related Art

Recently, the use of wireless internet connections has dramatically increased as the use of smart devices, such as mobile communications terminals, has expanded. Due to increased use of wireless internet, wireless internet services are also being diversified.

Many people commonly use smart devices to listen to music, search for news, use social networking services (SNS) (Twitter, Facebook, and the like), play games, or watch video content (movies, TV programs, and the like). In particular, users frequently use wireless Internet via smart devices to not only search the Internet, but also to watch high resolution (e.g., 1,920×1,080) and high definition (HD) (e.g., 60 frames per second) videos without compression or to play real-time online games. Accordingly, there is demand for faster wireless Internet transmission speeds.

One approach to increasing the of wireless Internet transmission speeds is multiple-input and multiple-output (MIMO) technology, which uses multiple antennas to increase wireless data capacity. However, MIMO is not applicable to terminals having insufficient space for implementing multiple antennas therein due to internal structural and spatial limitations or to existing smart devices having only one antenna.

Patent Document 1 relates to an apparatus and a method for sharing an antenna in a mobile communications system. The technology disclosed in Patent Document 1 is based on sharing an antenna in a base station, but is not related to sharing an antenna through an idle mobile communications terminal.

### RELATED ART DOCUMENT

### (Patent Document 1) Korean Patent Laid-Open Publication No. 10-2007-0011004

### SUMMARY OF THE INVENTION

An aspect of the present invention provides an apparatus and a mobile communications terminal for sharing a wireless LAN antenna capable of increasing transmission speed by utilizing an antenna of an idle communications terminal.

According to an aspect of the present invention, there is provided an apparatus for sharing a wireless LAN antenna, including: a switch connecting a signal input terminal to one of predetermined first, second and third paths; a first communications processing unit connected to the second path, the first communications processing unit synthesizing a data signal received in a preset first communications scheme and a data signal via the second path during the receiving operation and separating a data signal to be transmitted to transmit a part of the data signal in the first communications scheme and the other part of the data signal to the second path during the transmitting operation; a second communications processing unit connected to the third path, the second communications processing unit transmitting a data signal via the third path in a preset second communications scheme during the receiving operation and transmitting the received data signal in the second communications scheme to the third path during the transmitting operation; a wireless LAN communications unit connected to the first path and the first communications processing unit, and transmitting/receiving a wireless LAN signal to/from the first path or the first communications processing unit.

The switch may operate in synchronization with the first communications processing unit, the second communications processing unit, and the wireless LAN communications unit.

The first communications processing unit may include: a first communications unit processing transmission and reception of a data signal in the first communications scheme; and a signal synthesizing/separating unit performing reception or transmission, the signal synthesizing/separating unit synthesizing a data signal from the second path and a data signal from the first communications unit during the receiving operation and separating a data signal to transmit a part of the data signal to the second path and the other part of the data signal to the first communications unit during the transmitting operation.

The second communications processing unit may include: a second communications unit processing transmission and reception of a data signal in the second communications scheme; and a signal transmitting/receiving unit processing transmission and reception of a data signal between the third path and the second communications unit by performing receiving or transmitting.

The signal synthesizing/separating unit may include: a first switch including a common terminal, a first terminal and a second terminal, and connecting the common terminal to the first terminal or the second terminal; a second switch having a common terminal, a first terminal and a second terminal, the common terminal connecting the wireless LAN communications unit to the first terminal or the second terminal; a signal synthesizing unit synthesizing a data signal from the first communications unit and a data signal via the switch and the second path during the receiving operation; and a signal separating unit separating a data signal, provided by the wireless LAN communications unit to be transmitted, via the second switch, and transmitting a predetermined part of the data signal to the first communications unit and transmitting the other part of the data signal to the second path and the switch via the first switch during the transmitting operation.

The signal synthesizing/separating unit may include: a switching unit having a common terminal, a first terminal and a second terminal, the common terminal connecting the third path to the first terminal or the second terminal; a transmitting unit connected to the first terminal of the switching unit and transmitting a data signal from the second communications unit to the third path via the switching unit during the transmitting operation; and a receiving unit connected to the second terminal of the switching unit and transmitting a data signal via the third path to the second communications unit via the switching unit during the receiving operation.

According to another aspect of the present invention, there is provided a mobile communications terminal, including: a control unit performing controlling in each of a normal mode, a main mode and a sub mode; a switch, under the control of the control unit, connecting a signal input terminal to one of predetermined first, second and third paths; a first communications processing unit synthesizing a data signal received in a predetermined first communications scheme and a data signal via the second path during the receiving operation and separating a data signal to be transmitted to transmit a part of the data signal in the first communications scheme and the other part of the data signal to the second path during the transmitting operation, the receiving and transmitting operations being determined under the control of the control unit; a second communications processing unit transmitting a data signal via the third path in a predetermined second communications scheme during the receiving operation and transmitting the received data signal in the second communications scheme to the third path during the transmitting operation, the receiving and transmitting operations being determined under the control of the control unit; and a wireless LAN communications unit, under the control of the control unit, transmitting/receiving a wireless LAN signal to/from the first path or the first communications processing unit.

The control unit may generate a first control signal, a second control signal, a third control signal and a fourth control signal for control in each of the normal mode, the main mode and the sub mode, to be provided to the switch, the first communications processing unit, the second communications processing unit and the wireless LAN communications unit, respectively.

The switch, under the control of the control unit, may operate in synchronization with the first communications processing unit, the second communications processing unit, and the wireless LAN communications unit.

The first communications processing unit may include: a first communications unit processing transmission and reception of a data signal in the predetermined first communications scheme; and a signal synthesizing/separating unit performing reception or transmission, the signal synthesizing/separating unit, under the control of the control unit, synthesizing a data signal from the second path and a data signal from the first communications unit during the receiving operation and separating a data signal to transmit a part of the data signal to the second path and the other part of the data signal to the first communications unit during the transmitting operation.

The second communications processing unit may include: a second communications unit processing transmission and reception of a data signal in the predetermined second communications scheme; and a signal transmitting/receiving unit, under the control of the control unit, processing transmission and reception of a data signal between the third path and the second communications unit by performing receiving or transmitting.

The signal synthesizing/separating unit may include: a first switch including a common terminal, a first terminal and a second terminal, and connecting the common terminal to the first terminal or the second terminal according to a second signal from the control unit; a second switch having a common terminal, a first terminal and a second terminal, the common terminal connecting the wireless LAN communications unit to the first terminal or the second terminal according to the second signal from the control unit; a signal synthesizing unit synthesizing a data signal from the first communications unit and a data signal via the switch and the second path during the receiving operation according to the second signal from the control unit; and a signal separating unit separating a data signal, provided from the wireless LAN communications unit to be transmitted, via the second switch, and transmitting a preset part of the data signal to the first communications unit and transmitting the other part of the data signal to the second path and to the switch via the first switch during the transmitting operation according to the second signal from the control unit.

The signal transmitting/receiving unit may include: a switching unit having a common terminal, a first terminal and a second terminal, the common terminal connecting the third path to the first terminal or the second terminal according to a third control signal from the control unit; a transmitting unit connected to the first terminal of the switching unit and transmitting a data signal from the second communications unit to the third path via the switching unit during the transmitting operation according to the third control signal from the control unit; and a receiving unit connected to the second terminal of the switching unit and transmitting a data signal via the third path to the second communications unit via the switching unit during the receiving operation according to the third control signal from the control unit.

The first and second communications scheme may be one of wireless communication including wireless LAN communications, Bluetooth communications, Zigbee communications, and wired communications including USB communications.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an apparatus for sharing an wireless LAN antenna according to an embodiment of the present invention;

FIG. 2 is a block diagram of a mobile communications terminal according to an embodiment of the present invention;

FIG. 3 is a diagram illustrating the operation of switches according to an embodiment of the present invention;

FIG. 4 is a block diagram illustrating the configuration of a first communications processing unit according to an embodiment of the present invention;

FIG. 5 is a block diagram illustrating the configuration of a second communications processing unit according to an embodiment of the present invention;

FIG. 6 is a block diagram illustrating the configuration of a first communications unit (or second communications unit) according to an embodiment of the present invention; and

FIG. 7 illustrates an example in which two mobile communications terminals are used according to an embodiment of the present invention.

### DETAILED DESCRIPTION OF THE INVENTION

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

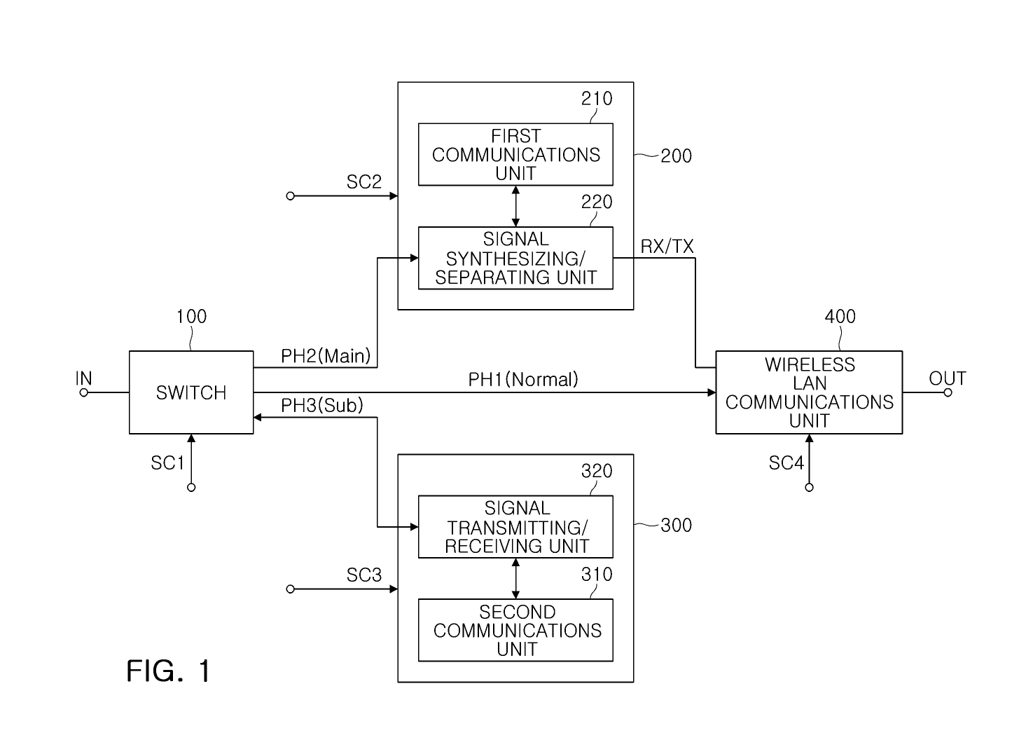

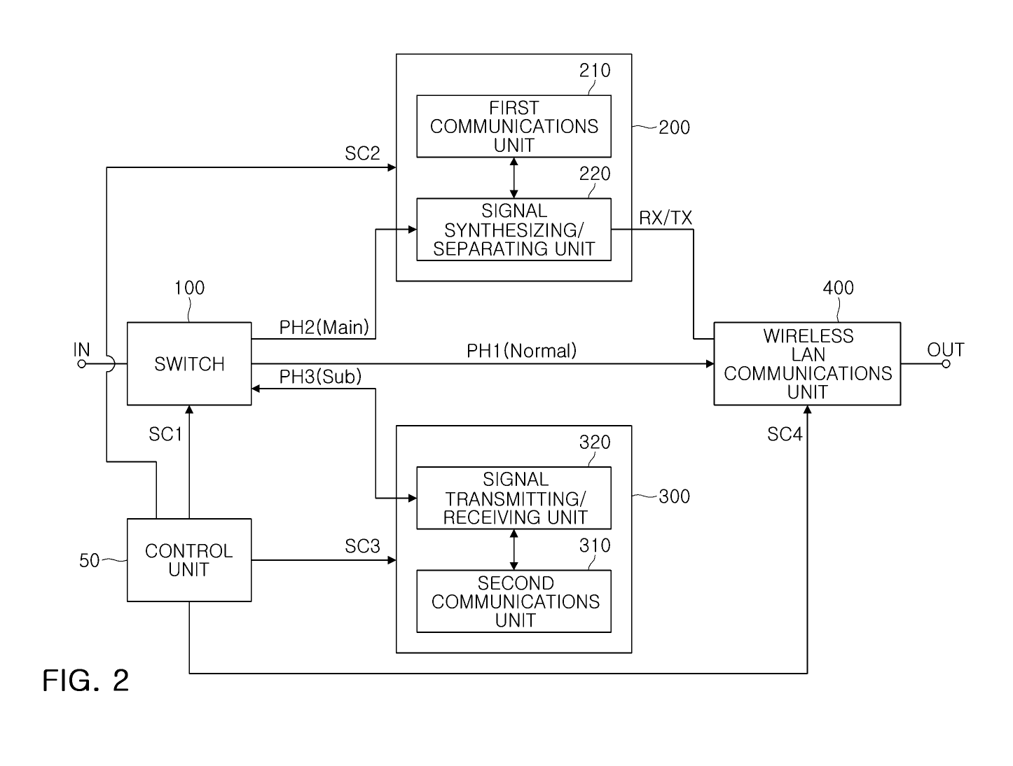

FIG. 1 is a block diagram of an apparatus for sharing a wireless LAN antenna according to an embodiment of the present invention, and FIG. 2 is a block diagram of a mobile communications terminal according to an embodiment of the present invention.

Referring to FIG. 1, the apparatus for sharing a wireless LAN antenna according to an embodiment of the present invention may include a switch 100, a first communications processing unit 200, a second communications processing unit 300, and a wireless LAN communications unit 400.

Referring to FIG. 2, the mobile communications terminal according to an embodiment of the present invention may include a control unit 50, a switch 100, a first communications processing unit 200, a second communications processing unit 300, and a wireless LAN communications unit 400.

Referring to FIGS. 1 and 2, each of the switch 100 may connect a signal input terminal IN to one of a first path PH1, a second path PH2 and a third path PH3, which are preset, under the control of the control unit 50.

Here, the first path PH1 may correspond to a normal mode in which ordinary operations are processed, the second path PH2 may correspond to a main mode in which a signal is received from a neighboring sub terminal, and the third path PH3 may correspond to a sub-mode in which a signal is transmitted to a neighboring main terminal.

Referring to FIG. 2, the control unit 50 may generate a first control signal SC1, a second control signal SC2, a third control signal SC3 and a fourth control signal SC4 for control in each of the normal mode, the main mode and the sub mode, to be provided to the switch 100, the first communications processing unit 200, the second communications processing unit 300 and the wireless LAN communications unit 400, respectively.

Referring to FIG. 2, by the first control signal SC1, the second control signal SC2, the third control signal SC3 and the fourth control signal SC4, the switch 100, the first communications processing unit 200, the second communications processing unit 300 and the wireless LAN communications unit 400 may be synchronized and controlled, respectively.

The first communications processing unit 200 is connected to the second path PH2, such that it may synthesize a data signal received in a predetermined first communications scheme and a data signal via the second path PH2 during the Rx operation, and separate a data signal to be transmitted so as to transmit one portion of the separated signal in the first communications scheme and to deliver the other portion of the separated signal to the second path PH2 during the Tx operation.

Here, the ratio to separate a data signal to be transmitted may be different depending on a predetermined ratio. For instance, the ratio between a main terminal and a sub terminal may be 50:50 or 60:40.

The second communications processing unit 300 is connected to the third path PH3, such that it may transmit a data signal via the third path PH3 in a predetermined second communications scheme during the Rx operation, and transmit a data signal received in the second communications scheme to the first path PH1 during the Tx operation.

The wireless LAN communications unit 400 is connected to the first path PH1 and the first communications processing unit 300, such that it may transmit/receive a wireless LAN signal to/from one of the first path PH1 and the first communications processing unit 300.

The first and second communications schemes may be one of wireless communications schemes including wireless LAN communications, Bluetooth communications, Zigbee communications, and wired communications schemes including USB communications (2.0 or 3.0).

Further, the communications scheme of the wireless LAN communications unit 400 may be a WiFi communications scheme conforming to one of IEEE 802.11, 802.11a, 802.11b, 802.11g, 802.11n and IEEE 802.11ac standards.

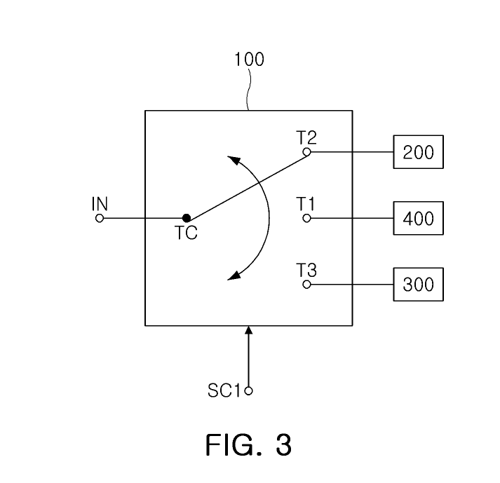

FIG. 3 is a diagram illustrating the operation of the switches according to an embodiment of the present invention.

Referring to FIGS. 1 to 3, the switch 100 may operate in synchronization with the first communications processing unit 200, the second communications processing unit 300 and the wireless LAN communications unit 400.

That is, the switch 100, according to the first control signal SC1 from the control unit 50, may connect its common terminal connected to the signal input terminal IN to one of its first terminal T1 connected to the first path PH1, its second terminal T2 connected to the second path PH2, and its third terminal T3 connected to the third path PH3.

For example, the switch 100, according to the first control signal SC1 from the control unit 50, may operate in synchronization with the first communications processing unit 200 operating according to the second control signal SC2, the second communications processing unit 300 operating according to the third control signal SC3, and the wireless LAN communications unit 400 operating according to the fourth control signal SC4.

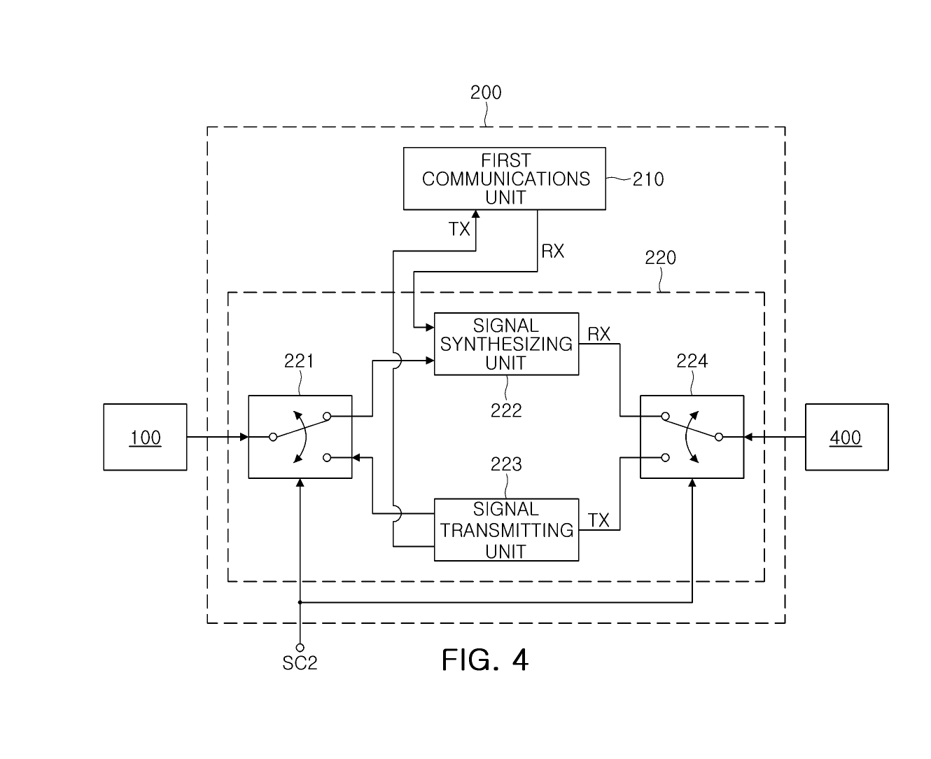

FIG. 4 is a block diagram illustrating the configuration of a first communications processing unit according to an embodiment of the present invention.

Referring to FIG. 1 to FIG. 4, the first communications processing unit 200 may include a first communications unit 210 and a signal synthesizing/separating unit 220.

The first communications unit 210 may process the transmission and reception of a data signal according to the first communications scheme, according to the second control signal SC2 from the control unit 50.

The signal synthesizing/separating unit 220, according to the second control signal SC2 from the control unit 50, may perform the Rx or Tx operation, such that it may synthesize a data signal from the second path PH2 and a data signal from the first communications unit 210 during the Rx operation, and may separate a data signal to transmit one of the separated signals to the second path PH2 and the other of the separated signals to the first communications unit 210 during the Tx operation.

As an exemplary implementation, the signal synthesizing/separating unit 220 may include a first switch 221, a signal synthesizing unit 222, a signal separating unit 223 and a second switch 224.

The first switch 221, according to the second control signal SC2 from the control unit 50, may connect its common terminal connected to the switch 100 to its first terminal connected to the signal synthesizing/separating unit 220 or its second terminal connected to the signal separating unit 223.

The second switch 224, according to the second control signal SC2 from the control unit 50, may connect its common terminal connected to the wireless LAN communications unit 400 to the first terminal connected to the signal synthesizing/separating unit 220 or the second terminal connected to the signal separating unit 223.

The signal synthesizing unit 222, according to the second control signal SC2 from the control unit 50, may synthesize a data signal from the first communications unit 210 and a data signal from the second path PH2 during the Rx operation, to provide it to the wireless LAN communications unit 400 via the second switch 224.

Further, the signal separating unit 223, according to the second control signal SC2 from the control unit 50, may separate the data signal, received from the wireless LAN communications unit 400 via the second switch 224 and which is to be transmitted, and transmit a predetermined part of the data signal to the first communications unit 210 and the other part of the data signal to the second path PH2 via the first switch 221 during the Tx operation.

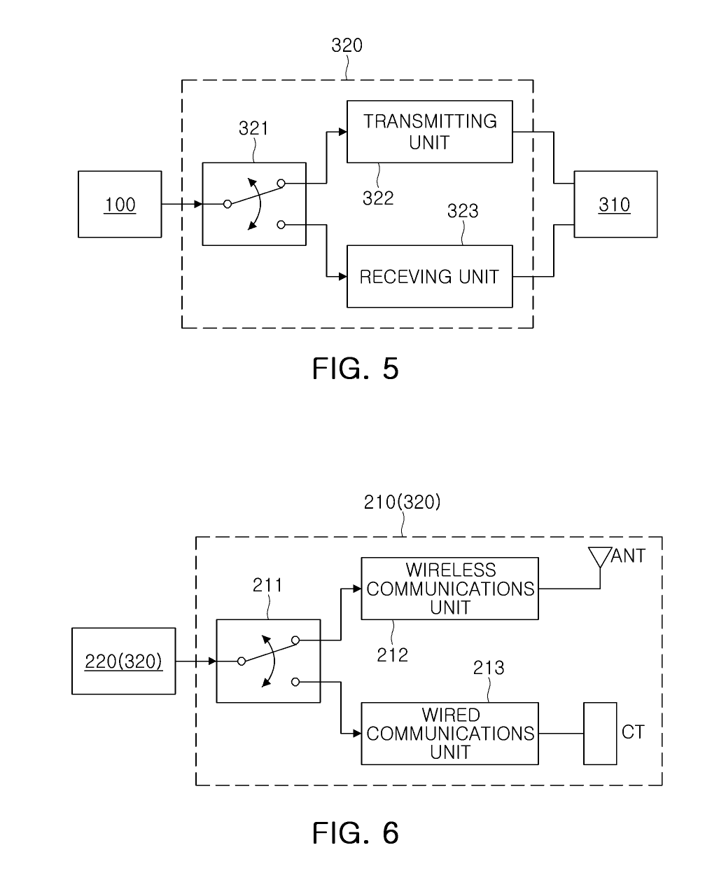

FIG. 5 is a block diagram illustrating the configuration of a second communications processing unit according to an embodiment of the present invention.

Referring to FIG. 1 to FIG. 5, the second communications processing unit 300 may include a second communications unit 310 and a signal transmitting/receiving unit 320.

The second communications unit 310 may process the transmission and reception of a data signal according to the second communications scheme, according to the third control signal SC3 from the control unit 50.

The signal transmitting/receiving unit 320, according to the third control signal SC3 from the control unit 50, may perform the Rx or Tx operation to process the transmission or reception of a data signal between the third path PH3 and the second communications unit 310.

As an exemplary implementation, the signal transmitting/receiving unit 320 may include a switching unit 321, a transmitting unit 322, and a receiving unit 323.

The switching unit 321, according to the third control signal SC3 from the control unit 50, may connect its common terminal connected to the third path PH3 to its first terminal connected to the transmitting unit 322 or its second terminal connected to the receiving unit 223.

The transmitting unit 322, according to the third control signal SC3 from the control unit 50, is connected to a first terminal of the switching unit 321 during the Tx operation, such that it may transmit a data signal from the second communications unit 310 to the first path PH1 and the switch 100 via the switching unit 321.

The receiving unit 323, according to the third control signal SC3 from the control unit 50, is connected to a second terminal of the switching unit 321 during the Rx operation, such that it may transmit a data signal via the switch 100 and the third path PH3 to the second communications unit 310 via the switching unit 321.

The above-described first and second communications units 210 and 310 may be implemented as a wireless communications unit 212 or a wired communications unit 213. Alternatively, as shown in FIG. 6, the first and second communications units 210 and 310 may include both of the wireless communications unit 212 and the wired communications unit 213.

FIG. 6 is a block diagram illustrating the configuration of a first communications unit (or second communications unit) according to an embodiment of the present invention. Referring to FIG. 6, the first communications unit 210 may be configured as shown in FIG. 6. Here, the second communications unit 310 has the same configuration and operation with the first communications unit 210, and, therefore, descriptions thereon will be replaced by those of the first communications unit 210.

The first communications unit 210 may include a switch 211, a wireless communications unit 212, and a wired communications unit 213.

The switch 211, according to the second control signal SC2 from the control unit 50, may connect its common terminal connected to the signal synthesizing/separating unit 220 to the terminal connected to the wireless communications unit 212 or the terminal connected to the wired communications unit 213.

In addition, the wireless communications unit 212 may be connected to an antenna ANT, and may employ wireless communication including wireless LAN communications, Bluetooth communications, and Zigbee communications, as described above. Further, the wired communications unit 213 is connected to a wired connector CT, and may employ wired communications scheme including USB communications (2.0 or 3.0), as described above.

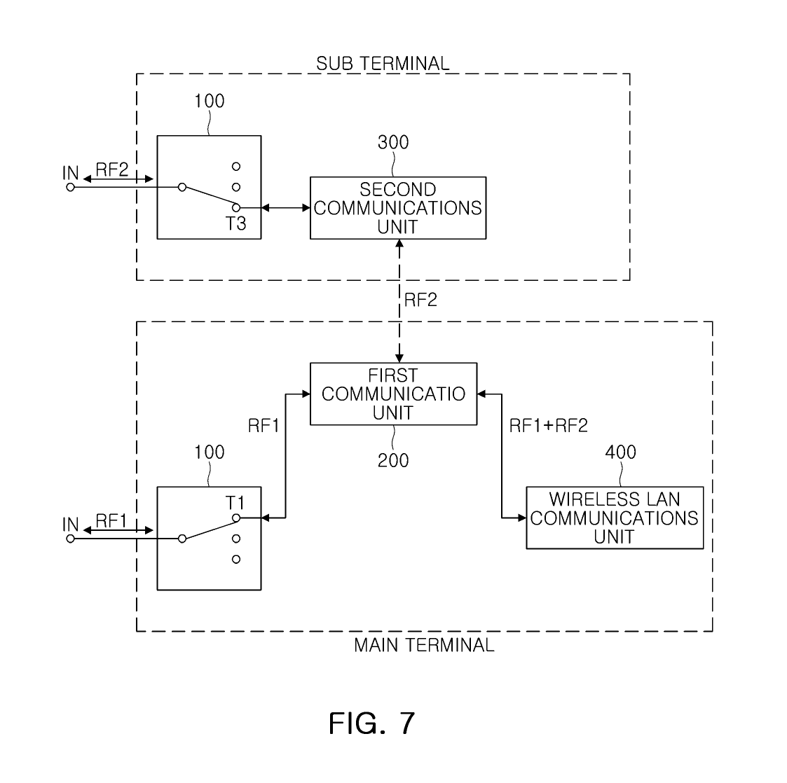

FIG. 7 illustrates an example in which two mobile communications terminals are used according to an embodiment of the present invention.

Referring to FIG. 7, one of the mobile communications terminals is set to be a main terminal, and the other of the mobile communications terminals is set to be a sub terminal, such that the main terminal uses an antenna of the sub terminal, an idle mobile communications terminal, thereby enabling high speed data communication.

That is, the second communications processing unit 300 connected to the switch 100 of the sub terminal may perform communication with the main terminal, and the first communications processing unit 200 connected to the switch 100 of the main terminal may perform communication with the sub terminal.

By performing the communication as shown in FIG. 7, the main terminal may share the antenna of the sub terminal, thereby increasing communication speed, as is done by MIMO.

As set forth above, according to embodiments of the present invention, transmission speed can be increased by utilizing an antenna of a nearby idle mobile communications terminal.

While the present invention has been shown and described in connection with the embodiments, it will be apparent to those skilled in the art that modifications and variations can be made without departing from the spirit and scope of the invention as defined by the appended claims.

What is claimed is:

1. An apparatus for sharing a wireless LAN antenna, comprising:
a switch connecting a signal input terminal to one of predetermined first, second and third paths;
a first communications processing unit connected to the second path, the first communications processing unit synthesizing a data signal received in a predetermined first communications scheme and a data signal via the second path during the receiving operation and separating a data signal to be transmitted to transmit a part of the data signal in the first communications scheme and the other part of the data signal to the second path during the transmitting operation;
a second communications processing unit connected to the third path, the second communications processing unit transmitting a data signal via the third path in a predetermined second communications scheme during the receiving operation and transmitting the received data signal in the second communications scheme to the third path during the transmitting operation; and
a wireless LAN communications unit connected to the first path and the first communications processing unit, and transmitting/receiving a wireless LAN signal to/from the first path or the first communications processing unit.

2. The apparatus of claim 1, wherein the switch operates in synchronization with the first communications processing unit, the second communications processing unit, and the wireless LAN communications unit.

3. The apparatus of claim 1, wherein the first communications processing unit includes:
a first communications unit processing transmission and reception of a data signal in the first communications scheme; and
a signal synthesizing/separating unit performing reception or transmission, the signal synthesizing/separating unit synthesizing a data signal from the second path and a data signal from the first communications unit during the receiving operation and separating a data signal to transmit a part of the data signal to the second path and the other part of the data signal to the first communications unit during the transmitting operation.

4. The apparatus of claim 1, wherein the second communications processing unit includes:
a second communications unit processing transmission and reception of a data signal in the second communications scheme; and
a signal transmitting/receiving unit processing transmission and reception of a data signal between the third path and the second communications unit by performing receiving or transmitting.

5. The apparatus of claim 3, wherein the signal synthesizing/separating unit includes:
a first switch including a common terminal, a first terminal and a second terminal, and connecting the common terminal to the first terminal or the second terminal;
a second switch having a common terminal, a first terminal and a second terminal, the common terminal connecting the wireless LAN communications unit to the first terminal or the second terminal;
a signal synthesizing unit synthesizing a data signal from the first communications unit and a data signal via the switch and the second path during the receiving operation; and
a signal separating unit separating a data signal, provided by the wireless LAN communications unit to be transmitted, via the second switch, and transmitting a predetermined part of the data signal to the first communications unit and transmitting the other part of the data signal to the second path and the switch via the first switch during the transmitting operation.

6. The apparatus of claim 4, wherein the signal transmitting/receiving unit includes:
a switching unit having a common terminal, a first terminal and a second terminal, the common terminal connecting the third path to the first terminal or the second terminal;
a transmitting unit connected to the first terminal of the switching unit and transmitting a data signal from the second communications unit to the third path via the switching unit during the transmitting operation; and
a receiving unit connected to the second terminal of the switching unit and transmitting a data signal via the third path to the second communications unit via the switching unit during the receiving operation.

7. The apparatus of claim 1, wherein the first and second communications schemes are one of wireless communication including wireless LAN communication, Bluetooth communications, Zigbee communications, and wired communications including USB communications.

8. A mobile communications terminal, comprising:
a control unit performing controlling in each of a normal mode, a main mode and a sub mode;
a switch, under the control of the control unit, connecting a signal input terminal to one of predetermined first, second and third paths;
a first communications processing unit synthesizing a data signal received in a predetermined first communications scheme and a data signal via the second path during the receiving operation and separating a data signal to be transmitted to transmit a part of the data signal in the first communications scheme and the other part of the data signal to the second path during the transmitting operation, the receiving and transmitting operations being determined under the control of the control unit;
a second communications processing unit transmitting a data signal via the third path in a predetermined second communications scheme during the receiving operation and transmitting the received data signal in the second communications scheme to the third path during the transmitting operation, the receiving and transmitting operations being determined under the control of the control unit; and
a wireless LAN communications unit, under the control of the control unit, transmitting/receiving a wireless LAN signal to/from the first path or the first communications processing unit.

9. The terminal of claim 8, wherein the control unit generates a first control signal, a second control signal, a third control signal and a fourth control signal for control in each of the normal mode, the main mode and the sub mode, to be provided to the switch, the first communications processing unit, the second communications processing unit and the wireless LAN communications unit, respectively.

10. The terminal of claim 8, wherein the switch, under the control of the control unit, operates in synchronization with the first communications processing unit, the second communications processing unit, and the wireless LAN communications unit.

11. The terminal of claim 8, wherein the first communications processing unit includes:
a first communications unit processing transmission and reception of a data signal in the predetermined first communications scheme; and
a signal synthesizing/separating unit, under the control of the control unit, performing reception or transmission, the signal synthesizing/separating unit synthesizing a data signal from the second path and a data signal from the first communications unit during the receiving operation and separating a data signal to transmit a part of the data signal to the second path and the other part of the data signal to the first communications unit during the transmitting operation.

12. The terminal of claim 8, wherein the second communications processing unit includes:
a second communications unit processing transmission and reception of a data signal in the predetermined second communications scheme; and
a signal transmitting/receiving unit, under the control of the control unit, processing transmission and reception of a data signal between the third path and the second communications unit by performing receiving or transmitting.

13. The terminal of claim 11, wherein the signal synthesizing/separating unit includes:
a first switch including a common terminal, a first terminal and a second terminal, and connecting the common terminal to the first terminal or the second terminal according to a second signal from the control unit;
a second switch having a common terminal, a first terminal and a second terminal, the common terminal connecting the wireless LAN communications unit to the first terminal or the second terminal according to the second signal from the control unit;
a signal synthesizing unit synthesizing a data signal from the first communications unit and a data signal via the switch and the second path during the receiving operation according to the second signal from the control unit; and
a signal separating unit separating a data signal, provided from the wireless LAN communications unit to be transmitted, via the second switch, and transmitting a predetermined part of the data signal to the first communications unit and transmitting the other part of the data signal to the second path and to the switch via the first switch during the transmitting operation according to the second signal from the control unit.

14. The terminal of claim 12, wherein the signal transmitting/receiving unit includes:
a switching unit having a common terminal, a first terminal and a second terminal, the common terminal connecting the third path to the first terminal or the second terminal according to a third control signal from the control unit;
a transmitting unit connected to the first terminal of the switching unit and transmitting a data signal from the second communications unit to the third path via the switching unit during the transmitting operation according to the third control signal from the control unit; and
a receiving unit connected to the second terminal of the switching unit and transmitting a data signal via the third path to the second communications unit via the switching unit during the receiving operation according to the third control signal from the control unit.

15. The terminal of claim 8, wherein the first and second communications schemes are one of wireless communication including wireless LAN communications, Bluetooth communications, Zigbee communications, and wired communications including USB communications.
